(19) United States
(12) Patent Application Publication
(10) Pub. No.: US 2010/0126124 A1
(43) Pub. Date: May 27, 2010

(54) BAG FILTER ASSEMBLY

(76) Inventor: RICHARD J. SCOTT, III, Fairhope, AL (US)

Correspondence Address: RICHARD J. SCOTT, III, 20297 MARION COURT, FAIRHOPE, AL, 36532, US

(21) Appl. No.: 12/277,737

(22) Filed: Nov. 25, 2008

(51) Int. Cl. B01D 46/02; B32B 7/04; B32B 7/12; B32B 7/08

(52) U.S. Cl. 55/365; 156/91

(57) ABSTRACT

A bag filter assembly is described; wherein the bag filter assembly includes a filter header, filter media, and a plurality of cover strips and one more living hinges. The header, the cover strips and the living hinges are injection molded as a single part from a plastic material. An adhesive is applied to the header. The pocket rings are also plastic injection molded as a single part with the header, the covers strips and the living hinge.

### FIELD OF THE INVENTION

This invention relates to bag filters. More particularly, the present invention relates to a bag filter assembly that is injection molded as a single part from a plastic material.

### BACKGROUND OF THE INVENTION

Bag filters are an established product in the treatment of fresh supply and recirculated air in buildings. Inflated by a steady airflow, bag filters offer a large media area for better dust holding and lower pressure drop. Bag filters are effectively used in applications where in-line space is not an issue and high dust holding over extended periods is required.

Bag filters consist of a series of individual synthetic media pockets supported by a rigid metal header frame supplied in certain depths. Bag filters are also available with plastic header frames, which are lighter in weight making them easier to transport, non-corrosive in a moist environment and generally easier to install.

The background art includes many different types of filter apparatus and bag filters for air filtration. For example, U.S. Patent Pub. No. 2004/0163370, filed in the name of Haufe et al., discloses a filter grid array having an air filter media removably mounted in a rigid frame. The filter media includes closed end pockets opposing the frontal opening and the frontal opening having an outer edge defining a circumference conforming to the circumference of the central opening of the rigid frame. The rigid frame includes a retaining ring, which secures the filter media to the frame, and a rod member for mounting the filter bag to the frame. The filter bag comprises a layer of non-woven synthetic fibers, however, other suitable filter media material may be employed.

U.S. Pat. No. 6,755,879, issued to Watvedt, describes a filter device wherein the filter element adsorbs or traps particles of liquid from the gas flow due to gravity wherein the particles are collected in a bottom portion. The filter device is a bag filter and formed of a synthetic material or a non-woven material having a coating of a water-repellent material on the surface of the fabric. Watvedt is primarily concerned with providing means necessary to collect liquid particles within the bottom or lower portion of the bag filter.

U.S. Pat. No. 5,215,609, issued to Sanders, relates to a pocket type unit filter with a frame inserted into the pocket produced with select pocket seams thereof being ultrasonically welded during a continuous automated manufacturing process. Sanders also describes amorphous network of polyester fibers and ultrasonic welding method for forming and manufacturing bag filters.

There are many problems associated with prior bag filters. For example, since they are assembled from at least 15 to 20 parts, more parts mean lesser integrity and greater assembly time and piece part price, and more chance for mistakes in the manufacturing process. Significant labor savings and increased integrity can be realized by eliminating costs associated with machining, cutting, screwing and clean-up operations following the machining and cutting steps.

What is needed is a bag filter assembly that consolidates the number of parts from al least 15 to 20 parts to 1 part and that eliminates costs associated with the machining and cutting of the bag filter assembly.

### SUMMARY OF THE INVENTION

The present invention is directed to a bag filter assembly. In one embodiment, the bag filter assembly includes a filter header; filter media; and a plurality of cover strips and one or more living hinges, coupled to the header, for holding pockets of the media. The header, the cover strips and the living hinges are injection molded as a single part from a plastic material. In another embodiment, the cover strips and the living hinges form one or more pocket rings, coupled to the header, for keeping the media open. An adhesive is applied to the header.

The media comprises one of the following: fiberglass and synthetic media. In one embodiment, the media is a polypropylene lofted microfiber. The plurality of cover strips comprises between about 6 and about 10 cover strips.

The filter assembly may be formed using any injection molding technique, equipment and/or machine known in the art.

In another embodiment, a method of fabricating a bag filter assembly is disclosed. The method comprises providing a filter header and fixing a plurality of cover strips and one or more living hinges to the header; wherein the fixing comprises injection molding the header, the cover strips and the living hinges as a single piece of molded plastic. The method also comprises coupling filter media to the single piece.

### BRIEF DESCRIPTION OF THE DRAWINGS

FIG. 1 shows a plan view of a bag filter assembly, in accordance with one embodiment of the present invention.

FIG. 2 shows a partial perspective view of bag filter assembly, in accordance with one embodiment of the present invention.

### DETAILED DESCRIPTION OF THE PREFERRED EMBODIMENTS

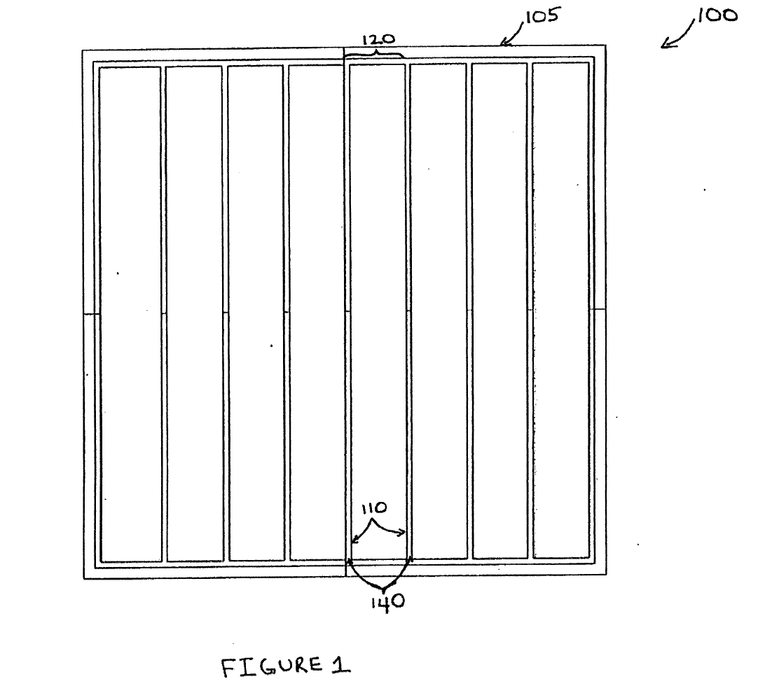

FIG. 1 describes a bag filter assembly 100 for air filtration that is injection molded as a single one-piece unit from a plastic material, in accordance with one embodiment of the present invention. The filter assembly 100 includes a header (or header frame) 105, a plurality of cover strips 110 and living hinges 140. The cover strips 110 hold pockets of filter media (not shown) with the living hinges 140 and eliminate any dust bypass between pockets of the media. In one embodiment, the cover strips comprise between 6 and 10 cover strips. The bag filter assembly 100 may be formed using any injection molding technique, equipment and/or machine known in the art.

An adhesive is applied to the periphery of the header 105 and, optionally, along the opening of each of the pockets of the media. This ensures that the pockets will not blow out or pull away from the header 105. In one embodiment, the cover strips 110 and the living hinges 140 forms a retainer ring 120, which holds and keeps the media open. The living hinges 140 snap the media to the cover strips. The header 105 or holding frame may be of any suitable type, e.g. for front, rear or side withdrawal mounting.

Any media, including any number or combination of materials, can be inserted or used in the filter assembly 100. For example, materials of dimensionally planned, spun or chopped glass fibers or synthetic, or natural fiber materials can be employed. In one embodiment, a fibrous material of a pre-selected mixture by weight and number of glass and synthetic fiber material can be employed. In some embodiments, ultra-fine fiberglass or synthetic media pockets are attached to the header 105. In other embodiments, dual denier polyester in 1 or 2 ply can be used. In another embodiment, the media is polypropylene lofted microfiber. The material may be treated, e.g. with an antimicrobial agent to resist microbial mould growth and build up of moulds or mildews.

The header 105, cover strips 110 and living hinges 140 are made of a plastic material and, in one embodiment, are made of the same material and are integrally formed in one piece by plastic injection molding. The plastic or thermoplastic material used for manufacturing the assembly 100 is at least one of the following: polystyrene, acrylonitrile butadiene styrene, polyamide, polypropylene, polyethylene, and polyvinyl chloride or PVC. Plastics reinforced with short fibers can also be injection molded.

The bag filter assembly 100 of the present invention allows inexpensive production of large quantities, while consolidating the number of parts from about 15 to 20 parts to 1 part. This decreases the piece part price while also decreases the labor costs involved.

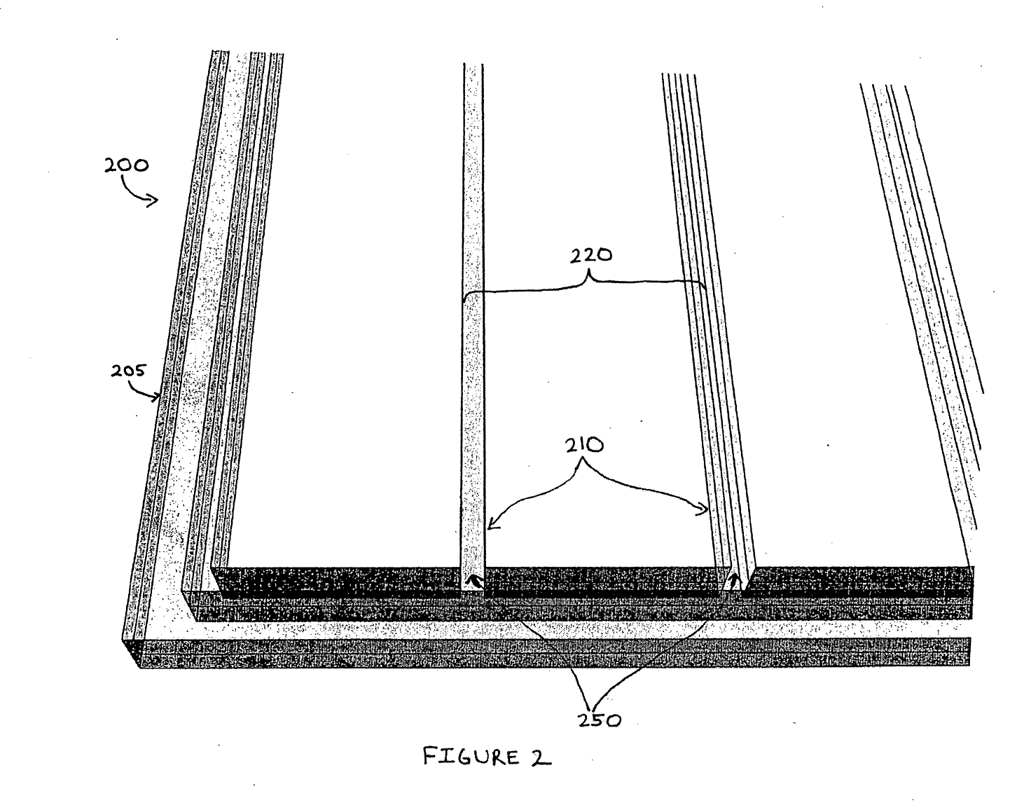

FIG. 2 describes a bag filter assembly 200 that is injection molded as a single one-piece unit from a plastic material, in accordance with one embodiment of the present invention. The filter assembly 200 includes a header 205, a plurality of cover strips 210 and living hinges 250. The header 205, the cover strips 210 and the living hinges 250 are made of a plastic material and are made of a plastic injection-molded part. The living hinges 250 snap the filter media (not shown) to the cover strips 210. In one embodiment, the header 205, the cover strips 210 and the living hinges 250 are made of the same plastic material. In another embodiment, the cover strips 210 and the living hinges 250 forms a retainer ring 220.

In another embodiment, the present invention includes a method of fabricating a bag filter assembly. The method includes providing a filter header; fixing a plurality of covers strips and one or more living hinges to the header; wherein the fixing comprises injection molding the header; the cover strips and the living hinges as a single piece of molded plastic; and coupling filter media to the single piece.

The bag filter assembly of the present invention consolidates the number of parts from at least 15 to 20 parts to 1 part and eliminates costs associated with the machining and cutting of the bag filter assembly. Fewer parts mean greater integrity and lower assembly time and piece part price, and less chance for mistakes in the manufacturing process. Significant labor savings and increased integrity are realized by eliminating costs associated with machining, cutting, screwing and clean-up operations following the machining and cutting steps.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modification may be made in the embodiments chosen for illustration without departing from the spirit and scope of the invention

What is claimed is:

1. A bag filter assembly comprising:
a. a filter header;
b. filter media; and
c. a plurality of cover strips and one or more living hinges, coupled to the header, for holding pockets of the media; wherein the header, the cover strips and the living hinges are injection molded as a single part from a plastic material.

2. The filter assembly of claim 1 wherein the cover strips and the living hinges forms at least one pocket ring, coupled to the header, for keeping the media open.

3. The filter assembly of claim 1 wherein an adhesive is applied to the header.

4. The filter assembly of claim 1 wherein the media comprises one of the following:
fiberglass and synthetic media.

5. The filter assembly of claim 1 wherein the media is a polypropylene lofted microfiber.

6. The filter assembly of claim 1 wherein the plurality of cover strips comprises between about 6 and about 10 cover strips.

7. The filter assembly of claim 2 wherein the pocket rings are plastic injection molded as a single part with the header.

8. A method of fabricating a bag filter assembly comprising:
a. providing a filter header,
b. fixing a plurality of cover strips and one or more living hinges to the header, wherein the fixing comprises injection molding the header, the cover strips and the living hinges as a single piece of molded plastic; and
c. coupling filter media to the single piece.

9. The method of claim 8 further comprising applying an adhesive to the header.

10. The method of claim 8 wherein the media comprises one of the following:
fiberglass and synthetic media.

11. The method of claim 8 wherein the media is a polypropylene lofted microfiber.

12. The method of claim 8 wherein the plurality of cover strips comprises between about 6 and about 10 cover strips.
